(19) United States
(12) Patent Application Publication
(10) Pub. No.: US 2024/0271970 A1
(43) Pub. Date: Aug. 15, 2024

(54) Fibre Optic Sensing

(71) Applicant: Optasense Holdings Limited, Camberley, Surrey (GB)

(72) Inventors: Roger Crickmore, Camberley, Surrey (GB); Alastair Godfrey, Camberley, Surrey (GB)

(21) Appl. No.: 18/567,009

(22) PCT Filed: Jun. 10, 2022
(86) PCT No.: PCT/GB2022/051451

§ 371 Date: Dec. 4, 2023

(30) Foreign Application Priority Data
Jun. 11, 2021 (GB) GB2108396.9

(51) Int. Cl. G01D 5/353

(52) U.S. Cl. CPC G01D 5/35351

(57) ABSTRACT

This application describes methods and apparatus for fibre optic sensing. A receive unit includes an optical arrangement configured to receive coherent optical radiation that has propagated through a sensing optical fibre and to form first and second optical signals, wherein the second optical signal comprises optical radiation received from the sensing optical fibre later than the optical radiation of the first optical signal by a defined time period. A photodetector detects the first optical signal mixed with the second optical signal and a processor demodulates a derivative signal formed by interference of the first and second optical signals. First and second receive units may be located at opposite ends of a cable structure to provide respective measurement signals and a signal processor can process the two measurement signals to locate a disturbance.

This application relates to methods and apparatus for fibre optic sensing.

Various different techniques for fibre optic sensing are known and have been proposed for detecting strain, e.g. due to incident acoustic stimuli or other disturbances.

For instance, one type of fibre optic sensor is based on the use of fibre Bragg gratings (FBGs). An optical fibre is configured to include, or connect to, a plurality of FBGs at different points along its length. In use, the optical fibre is interrogated by launching optical radiation into the sensing fibre. Each FBG causes some of the interrogating light to be reflected with a wavelength that depends on the properties of the grating. A disturbance, such as a strain due to an incident acoustic wave, causes a change in the spacing of the grating and hence a detectable change in the wavelength of the light reflected from the grating. FGB based sensing can be usefully employed in a number of applications but does require the use of optical fibres that are specialised for sensing.

Another type of fibre optic sensing for dynamic strains is distributed fibre optic sensing based on coherent Rayleigh backscatter, for instance distributed acoustic sensing (DAS). DAS can use a standard unmodified communications optical fibre as the sensing fibre. The sensing optical fibre is interrogated with coherent optical radiation and backscatter from inherent scattering sites within the sensing fibre is detected. Disturbances acting on a portion of the sensing fibre can vary the distribution of the scattering sites, which varies the properties of the backscatter from that portion, which can be detected so as to provide an indication of disturbances acting on the relevant portion.

DAS can be usefully used to provide sensing from each of a plurality of sensing portions of the sensing optical fibre. However, for DAS there will generally be a maximum distance into a sensing fibre from which backscatter can be received and analysed to provide a reliable indication of disturbances, and in some cases the maximum distance or range may be of the order of a few tens of kilometres or so. In some instances, it may be desirable to able to sense any disturbances acting on longer lengths of optical fibre.

Recently, it has been proposed that disturbances acting on relatively long lengths of optical fibre may be determined by transmitting light from a first laser through the optical fibre, and then interfering the light received at the far end with light from a second laser to detect any variation in propagation time through the optical fibre caused by disturbances acting on the optical fibre. This does, however, require the use of two ultra-stable lasers which that are phase stable to the extent that any phase variations can be attributed to propagation time variations arising from disturbances of the fibre, and does also require the frequencies of the two lasers to be controlled so as to differ from one another by an amount less than the bandwidth of the optical detection circuit, and thus the sensing can be relatively complex and costly.

Embodiments of the present disclosure relate to improved methods and apparatus for fibre optic sensing.

Thus, according to an aspect of the disclosure, there is provided a fibre optic sensing apparatus comprising a first receive unit. The first receive unit comprises an optical arrangement configured to receive coherent optical radiation that has propagated through a sensing optical fibre and to form first and second optical signals from the optical radiation received, wherein the second optical signal comprises optical radiation received from the sensing optical fibre later than the optical radiation of the first optical signal by a defined time period. A photodetector is configured to detect the first optical signal mixed with the second optical signal and a processor is configured to process an output of the photodetector to demodulate a derivative signal formed by interference of the first and second optical signals.

The optical arrangement may be configured to direct optical radiation received from the sensing optical fibre into first and second optical paths to provide the first and second optical signals, wherein the first optical path comprises an optical delay for imposing a delay relative to the second optical path equal to said defined time period. In some examples the optical delay may comprise a fibre optic loop. In some examples, the optical delay may be configured such that said defined time period is within the range of 5-25 microseconds inclusive.

In some examples, at least one of the first and second optical paths may comprise a modulator configured to apply a frequency shift to optical radiation in the relevant optical path such that the first optical signal differs in frequency from the second optical frequency by a defined frequency difference. The processor may be configured to demodulate the derivative signal at a carrier frequency equal to said defined frequency difference.

In some examples, the receive apparatus may be configured such that the optical radiation received from the sensing optical fibre comprises a repeating sequence of pulses pairs, each pulse pair comprising a first pulse at a first frequency and a second pulse at a second different frequency. The defined time period of the optical delay may be configured such that, when mixed together, at least part of a first pulse of a pulse pair of the first optical signal overlaps with at least part of a second pulse of a pulse pair of the second optical signal. The defined time period of the optical delay may be configured to substantially match a temporal separation between the first and second pulses of a pulse pair.

The fibre optic sensing apparatus may further comprise a first transmit unit comprising an optical source configured to launch coherent optical radiation into the sensing optical fibre. In embodiments where the optical radiation received from the sensing optical fibre comprises a repeating sequence of pulses pairs, each pulse pair comprising a first pulse at a first frequency and a second pulse at a second different frequency, the first transmit unit may comprise a coherent optical source and at least one modulator configured to modulate optical radiation from the coherent optical source to form said pulse pairs.

Embodiments also relate to the fibre optic sensing apparatus including the sensing optical fibre. In some implementations the sensing optical fibre may be at least 1000 km in length.

In some embodiments, the first transmit unit may be located at the first end of a fibre optical cable structure comprising the sensing optical fibre and the first receive unit may be located at a second end of said fibre optical cable structure, the first receive unit being configured to generate a first measurement signal. The fibre optic sensing apparatus may further comprise a second transmit unit located at the second end of the fibre optical cable structure and a second receive unit located at the first end of the fibre optical cable structure. The second receive unit may be configured to receive optical radiation transmitted from the second transmit unit via the fibre optic cable structure, and to process the received optical radiation in the same way as the first receive unit to form a second measurement signal.

The fibre optic sensing apparatus may further comprise a signal processor configured to correlate the first and second measurement signals to identify a disturbance signature in both the first and second measurement signals. The signal processor may be further configured to determine any time difference between the disturbance signature in the first and second measurement signals and to determine a location along the fibre optical cable structure for the disturbance based on the determined time difference. In some cases, the second transmit unit may be configured to transmit optical radiation to the second receive unit via the same sensing optical fibre as the first transmit unit and first receive unit.

Another aspect relates to a method of fibre optic sensing comprising: launching coherent optical radiation into a sensing optical fibre at a first end of a fibre optic cable structure; receiving, at a second end of the fibre optical cable structure, the optical radiation that has propagated through the sensing optical fibre; forming first and second optical signals from the optical radiation received at the second end, wherein the second optical signal comprises optical radiation received from the sensing optical fibre later than the optical radiation of the first optical signal by a defined time period; mixing the first optical signal with the second optical signal and detecting the mixed signal; and processing the detected mixed signal to demodulate a derivative signal formed by interference of the first and second optical signals to generate a first measurement signal.

The method may further comprise launching coherent optical radiation into a sensing optical fibre at the second end of the fibre optic cable structure; receiving, at a first end of the fibre optical cable structure, the optical radiation that has propagated through the sensing optical fibre; forming third and fourth optical signals from the optical radiation received at the first end, wherein the third optical signal comprises optical radiation received from the sensing optical fibre later than the optical radiation of the fourth optical signal by a defined time period; mixing the third optical signal with the fourth optical signal and detecting the mixed signal; and processing the detected mixed signal to demodulate a derivative signal formed by interference of the first and second optical signals to generate a second measurement signal.

The method may further comprise correlating the first and second measurement signals to identify a disturbance signature in both the first and second measurement signals, identify a time difference between the disturbance signature in each measurement signal and determine a location of the disturbance along the fibre optic cable structure based on the determined time difference.

The method may be implemented in any of the variants as described with reference to the apparatus of the first aspect.

In a further aspect there is provided a fibre optic sensing apparatus, comprising a signal processor configured to receive a first measurement signal and a second measurement signal from respective first and second fibre optic sensing receive units located at opposite ends of a fibre optic cable structure, wherein each of the first and second measurements signals comprise signals generated by receiving coherent optical radiation that has propagated through a sensing optical fibre of the fibre optical cable structure, mixing a first optical signal formed from the optical radiation received with a second optical signal comprising optical radiation received from the sensing optical fibre later than the optical radiation of the first optical signal by a defined time period and detecting and demodulating a derivative signal formed by interference of the first and second optical signals. The signal processor is configured to identify a disturbance signature in both the first and second measurement signals, identify a time difference between the disturbance signature in each measurement signal and determine a location of the disturbance along the fibre optic cable structure based on the determined time difference.

The signal processor may operate as described in any of the embodiments discussed herein.

A further aspect provides a method of fibre optic sensing comprising: receiving a first measurement signal and a second measurement signal from respective first and second fibre optic sensing receive units located at opposite ends of a fibre optic cable structure, wherein each of the first and second measurements signals comprise signals generated by receiving coherent optical radiation that has propagated through a sensing optical fibre of the fibre optical cable structure, mixing a first optical signal formed from the optical radiation received with a second optical signal comprising optical radiation received from the sensing optical fibre later than the optical radiation of the first optical signal by a defined time period and detecting and demodulating a derivative signal formed by interference of the first and second optical signals. The method involves identifying a disturbance signature in both the first and second measurement signals; identifying a time difference between the disturbance signature in each measurement signal; and determining a location of the disturbance along the fibre optic cable structure based on the determined time difference.

Note that unless expressly indicated to the contrary or clearly incompatible, any feature of any of the embodiments described herein may be used in combination with any one or more features of any of the other described embodiments.

Embodiments, and feature of embodiments of the present disclosure, will now be described by way of example only with respect to the accompanying drawings, of which:

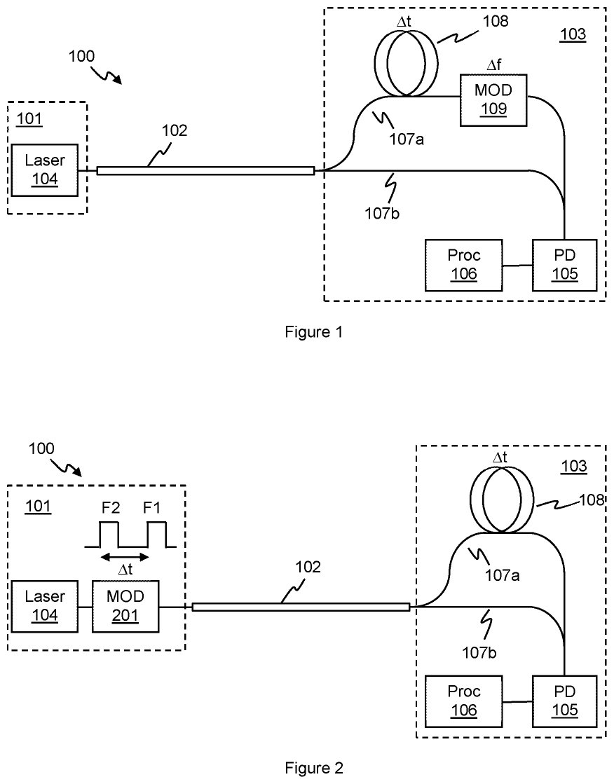

FIG. 1 illustrates an example of a sensor apparatus according to an embodiment;

FIG. 2 illustrates an example of a sensor apparatus according to another embodiment;

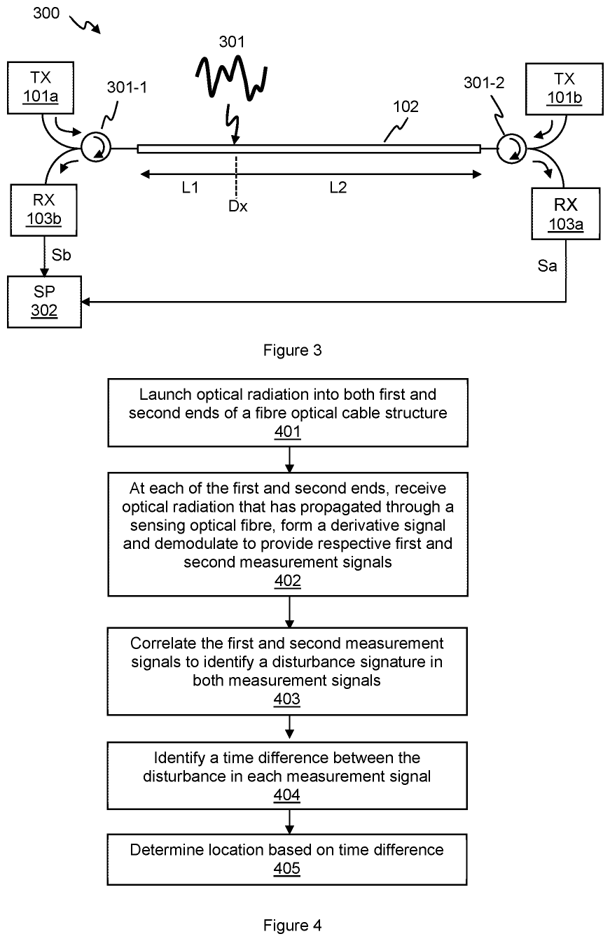

FIG. 3 illustrates an example of bidirectional sensing; and

FIG. 4 illustrates a flow chart of a method of sensing according to an embodiment.

Embodiments of the present disclosure relate to methods and apparatus for fibre optic sensing, and in particular to fibre optic sensing to detect disturbances on an optical fibre by analysing optical radiation which has been transmitted through the optical fibre used as the sensing fibre.

In embodiments of the present disclosure, optical radiation from a coherent optical source is launched into a launch end of the sensing optical fibre and the optical radiation that propagates through the sensing optical fibre and is received at the far end is used to form first and second optical signals, where there is a time difference Δt in the time at which the optical radiation of the first and second optical signals respectively is received from the sensing optical fibre. Thus the optical radiation of the second optical signal may be received from the optical fibre a time which is Δt later than the time of receipt of the radiation of the first optical signal. The first and second optical signals are mixed together and interfere with one another, which results in an interference component. In use, disturbances on the sensing fibre that result in a change in the optical path length of the sensing optical fibre will result in a change in the characteristics, e.g. phase, of the interference component. A signal formed from the mixed first and second optical signals can thus be detected and analysed to determine any disturbances acting on the sensing optical fibre.

This avoids the need for the use of ultra-stable lasers with relatively complex control systems for maintaining consistency of two lasers which may be a long distance apart.

FIG. 1 illustrates an example of a fibre optic sensor arrangement 100 that uses this principle. FIG. 1 illustrates that a transmit unit 101 is configured to generate coherent optical radiation for launch into a launch end of an optical fibre 102 which it is wished for monitor. The optical radiation propagates through the optical fibre and is received at the other end, i.e. the receive end, by a receive unit 103, which analyses the received optical radiation to detect any disturbances acting on the optical fibre 102.

The optical fibre 102, which may be referred to herein as the sensing optical fibre or just sensing fibre (or sometimes as the fibre under test), may be any suitable optical fibre and may, for instance, be a standard single mode optical fibre of the type typically used for telecommunications. The sensing optical fibre 102 may be deployed in an area of interest to be monitored and, in some cases, may be specifically deployed to allow for sensing, although in some instances, use may be made of an existing optical fibre which is already deployed in the region of interest and which may have been originally deployed for some other performance, e.g. for communications. Depending on the particular use case, the sensing fibre may be deployed in a relatively permanent manner, e.g. being buried or otherwise secured in place. In some applications, the sensing optical fibre 102 may be removably connected to the transmit unit 101 and receive unit 103 when required for sensing, but if continuous sensing is not required, at least one of the transmit unit 101 and receive unit 103 may be removed when not in use, possibly leaving the sensing optical fibre 102 in situ.

The sensing optical fibre 102 can be many kilometres in length and can, in some applications, be hundreds of kilometres in length, for example in some cases the sensing optical fibre may be greater than 200 km, or greater than 500 km in length, and in some cases may be 1000 km or more in length. Note whilst the sensing fibre may be one continuous optical fibre, the sensing fibre could, in some applications, be formed from various optical fibre sections that have been spliced together or otherwise optically connected. In some cases at least part of the sensing optical fibre 102 may be formed as part of a submarine cable structure, e.g. as part of a telecommunications cable or a submarine power cable. As will be understood by one skilled in the art, if the sensing cable is very long it may also include one or more optical amplifiers at locations along its length which are installed to ensure that the optical signal to noise ratio (OSNR) never falls below some prescribed level.

The transmit unit 101 includes an optical source, such as laser 104, for generating coherent optical radiation for launch into the launch end of the sensing optical fibre 102. Note that as used herein the term “optical” is not restricted to the visible spectrum and, as used herein, the term optical refers to any electromagnetic radiation which may be guided by, and scattered from within, an optical fibre. For the avoidance of doubt, optical radiation as used herein includes infrared radiation and ultraviolet radiation. Any reference to “light” should also be construed accordingly.

Optical radiation which has propagated through the sensing optical fibre 102 is received at the receive end by the receive unit 103. The receive unit 103 comprises a photodetector 105 for detecting optical radiation received from the sensing optical fibre 102 and a processor 106 for analysing the detected radiation so as to determine any disturbances acting on the sensing optical fibre.

As noted above, in embodiments of the present disclosure, the receive unit 103 comprises an optical arrangement that is configured to generate first and second optical signals from the optical radiation received from the sensing optical fibre, where the optical radiation of the second optical signal is received from the sensing optical fibre at a time which is Δt later than the time of receipt of the radiation of the first optical signal.

FIG. 1 illustrates that the optical arrangement for generating the first and second optical signals comprises first and second optical paths, 107a and 107b. Optical radiation received from the receive end of the sensing optical fibre 102 is split into the first and second optical paths 107a and 107b, e.g. by a suitable splitter (not separately illustrated). The first optical path 107a includes an optical delay 108, such as an optical fibre loop or the like, such that optical radiation passing via the first path 107a is delayed by an amount of time Δt with respect to optical radiation passing via the second path. The radiation from the first and second paths is mixed together prior to detection by the photodetector 105.

The optical delay 108 means that optical radiation received from the sensing fibre 102 and passing via the first path is mixed with optical radiation passing via the second optical path that was received from the sensing optical fibre a time Δt later. The optical radiation from the first optical path interferes with the optical radiation from the second optical path to provide an interference component. In effect, the first and second optical paths of the receive unit define an interferometer. As will be understood by one skilled in the art, the output of such an interferometer will depend on the relative phase of the optical radiation received from the sensing optical fibre 102 and the extent of the relative delay Δt applied in the first optical path. The amount of the relative delay Δt does not vary, in use, during sensing operation and thus, in the absence of any disturbance acting on the sensing optical fibre, the properties of the interference component would not be expected to vary. However if a disturbance is acting on the sensing optical fibre that changes the optical path length of the sensing optical fibre, this may result in an effective variation in the relative phase of optical radiation received from the sensing optical fibre compared to that of the optical radiation received at a time Δt later. Such a disturbance will thus lead to a detectable variation in the properties of the interference component.

By interfering the optical radiation received from the sensing optical fibre 102 with optical radiation received at a time Δt earlier, a derivative signal is generated indicative of the extent of any change in optical path length of the sensing optical fibre 102 over the period Δt.

In at least some implementations, to allow for demodulation of the derivative signal, the optical radiation of the first optical path may be arranged to have a frequency difference to the optical radiation of the second optical path of Δf. If the optical radiation of the first and second optical path differs by a frequency difference of Δf, the resulting interference component will comprise a signal component at a carrier frequency equal to Δf and the signal of interest, e.g. the derivative signal due to a disturbance acting on the sensing optical fibre 102, will be imposed on the carrier frequency, i.e. as a variation in phase.

In some examples, the difference in frequency may be at least partly imposed at the receive end and thus at least one of the first and second optical paths may include a modulator 109 for imparting a frequency shift to the optical radiation in that path. FIG. 1 illustrates a modulator 109, for example an acousto-optic modulator (AOM), in the first optical path for imparting a frequency shift of Δf to the radiation in the first optical path 107a, before mixing with the optical radiation of the second optical path 107b. In at least some examples a suitable AOM may apply a frequency difference of a few tens of megaHertz, for instance a frequency shift of say 30-50 MHz inclusive in some examples.

The mixed signal is received by the photodetector 105 and the detected signal sampled and processed by the processor 106 to demodulate the signal of interest. The photodetector will be sampled at a sufficient rate to allow the carrier signal to be demodulated and thus the sample rate may be at least 2Δf. The sampled output of the photodetector may be processed to demodulate the carrier signal in a number of ways, as would be understood by one skilled in the art. For example, the detected signal could be multiplied by sine and cosine components at the carrier frequency to provide I and Q values that can then be converted to an indication of phase. The resulting phase signal can be monitored to detect any variation due to a disturbance acting on the sensing fibre that results in a change in optical path length of the sensing optical fibre, which may be due to physical length changes and/or modulation of refractive index.

The magnitude of the derivative signal depends on the magnitude of the disturbance and also the relevant time difference between the first and second optical signals, i.e. the delay Δt. For instance, if the variation in optical path length of the sensing optical fibre 102 due to a stimulus is given by S(t), the derivative signal D(t) will be given by:

$$D ( t ) = Δ t \cdot δ S ( t ) / δ s \qquad Eqn . 1$$

If, for example Δt was 10 μs and the variation in optical path length S(t) had the form of a sine wave at a frequency of say 1 kHz and with an amplitude A, the derivative signal would also be a signal at the same frequency, but with an amplitude of 0.063A.

The time delay Δt may be selected with regard to the expected disturbances of interest. The time delay may be set to be short enough to provide sufficient sampling of the disturbance of interest, but long enough so as to allow for a sufficient change in optical path length to occur. In some applications a delay of the order of a few microseconds or a few tens of microseconds, e.g. a delay within the range of 5 μs to 25 μs inclusive may be used, such as a delay of 10 μs or so. A delay of 10 μs could be achieved by a fibre optic delay loop of the order of 2 km in length.

Note that, in order to provide a consistent derivate signal, the duration of the time delay Δt does not vary in use during a given sensing operation, but in some embodiments the delay may be configurable, i.e. there may be different delays that can be configured to provide a selected delay for a particular sensing application. Thus, before starting sensing operation the appropriate delay may be selected and configured and then used in a subsequent sensing operation. If, in use, different sensing parameters are required, the current sensing operation could be stopped, the delay reconfigured, and sensing operation restarted with the different delay. In effect the sensing apparatus may be operable in different modes having different delays.

Additionally or alternatively, in some embodiments optical radiation received from the sensing optical fibre 102 could further be split into at least a third optical path which is configured to provide a different relative delay to that of the second optical path. Optical radiation from the third optical path could be mixed with optical radiation from the first optical path to provide a second interference component that corresponds to a derivate signal based on the relative delays of the first and third optical paths. In some instances the first and third optical paths could be mixed separately from the first and second optical paths and the relevant mixed signals detected by separate detectors, although in some cases the radiation from the third signal path could be arranged so that the frequency differences between each of the three possible pairs of paths were all different and the light from all three paths could be mixed on a single photodetector generating three different carrier frequencies that could be independently demodulated.

As noted, as the optical radiation which is received from the sensing optical fibre 102 is mixed with a delayed version of itself to form an interference component which is detected and demodulated, there is no need for a second laser as part of the detecting apparatus of the receive unit. As there is no laser required for detection at the receive end, there is also no need to ensure stability between a laser at the launch end and a laser at the receive end. As the optical radiation which is interfered corresponds to radiation emitted from the transmit laser 104 with a short time delay, the laser 104 does not need to be an ultra-stable one.

The embodiment of FIG. 1 can be operated in continuous wave operation, at least for defined measurement periods (provided that the period of illumination is at least as long as the delay period Δt) so as to allow for at least some self-interference at the receive end.

FIG. 1 illustrates that a frequency difference between the radiation of the first and second optical paths may be implemented by the receive unit 103, e.g. by modulator 109 as described above.

In some embodiments, the optical radiation launched into the sensing optical fibre may comprise optical radiation at at least a first and a second frequency which is configured so that at least some of the radiation at the first frequency which is received at the receive end at a first time can be interfered with radiation at the second frequency which is received at the time Δt later.

FIG. 2 illustrates another example of a sensing apparatus 200 according to an embodiment, in which similar components are identified using the same reference numerals. In the implementation of FIG. 2, the transmit unit 101 comprises at least one modulator 201, such as an acousto-optic modulator for imparting a frequency modulation to the optical radiation launched into the sensing optical fibre 102.

In this example optical radiation from the laser 104 is modulated by at least one modulator 201 to form a series of pulse pairs, each pulse pair comprising first and second spatially separated pulses at first and second different frequencies f1 and f2. The receive unit comprises first and second optical paths 107a and 107b, where the first optical path 107a includes an optical delay providing a delay Δt as described with respect to FIG. 1. As described with respect to FIG. 1, optical radiation received from the sensing optical fibre, i.e. from each transmitted pulse pair, may be split into both the first and second optical paths 107a and 107b.

In one embodiment the pulses launched into sensing optical fibre 102 are configured with respect to the delay Δt at the receive unit 103, such at least part of the first pulse of a pulse pair that has been delayed via the first optical path 107a is coincident with at least part of the second pulse of that pulse pair which has travelled via the relatively undelayed second optical path 107b. Thus optical radiation received from the first pulse at frequency F1 which has passed via the first optical path 107a and been delayed by the delay period Δt can be mixed with optical radiation from the second pulse that has travelled via the second, undelayed, optical path 107b so as to provide an interference component at the carrier frequency f1-f2, which comprises the derivate signal of interest.

The pulse pair is thus generated by the transmit unit 101, e.g. by the modulator 201, such that at least part of the first pulse is temporally spaced from at least part of the second pulse by the period Δt (and/or equivalently the delay period Δt at the receive unit is set based on a temporal spacing of the first and second pulses of the pulse pair). In at least some implementations the pulses may be non-overlapping pulses, which have substantially the same duration as one another and the start of the second pulse may be temporally spaced delayed from the start of the second pulse by a period substantially equal to the time delay Δt.

The sequence of pulse pairs can be transmitted with any suitable interval between pulse pairs that allows the desired interference signal, e.g. the interference between a delayed first pulse of a pulse pair and an undelayed second pulse of a pulse pair, to be detected, without any unwanted interference. In some embodiments the time interval between the first and second pulses of each pulse pair may be equal to the delay period Δt and the time interval between successive pulse pairs may be equal to twice the delay period, i.e. 2Δt. The time interval between the first and second pulses of a pulse pair would be equal to Δt, and the time interval between a second pulse of one pulse pair and the first pulse of the subsequent pulse pair would also be equal to Δt.

Thus would mean that a series of pulses at alternating frequencies F1, F2, F1, F2 . . . is launched into the sensing fibre with the delay between each individual pulse being Δt. This series of pulses is received by the receive unit 103 and split into the first and second optical paths 107a and 107b. In which case each pulse at F1 which is delayed via the first optical path 107a is mixed with a pulse at F2 from the undelayed second optical path 107b, and also each pulse at F2 from the delayed first optical path 107a is mixed with a pulse at F1, from the subsequent pulse pair from the undelayed second optical path 107b. This effectively provides two interleaved sequences for sampling, i.e. a first series of the undelayed F1 pulses mixed with the delayed F2 pulses with a 2Δt sample period interleaved with a second series of the undelayed F2 pulses mixed with delayed F1 pulses, again at a 2Δt sample period. Either or both of these time series could be demodulated to provide the derivative signal, however the phase of the signals from the two time series are inverted. Following separate demodulation the two times series could be combined provided the inversion between them is taken into account.

The use of pulses in the manner described with reference to FIG. 2 does therefore constrain the sample rate based on the amount of delay applied, and timing of the pulses. The carrier frequency, i.e. the frequency difference F1-F2 in this embodiment is selected so as to provide a carrier frequency that can be suitably demodulated at the relevant sample rate. This sample rate limitation can be avoided by the continuous wave operation described with reference to FIG. 1, which has the benefit of reducing the system noise floor. However, in general, it is advantageous to avoid any significant non-linear optical effects for the optical radiation propagating in the sensing optical fibre and the optical power than can be launched into the sensing optical fibre without any significant non-linear effects may generally be lower for continuous wave illumination compared to pulsed operation and thus in some instances there may be advantages in the pulsed operation to allow for launch of higher optical power.

Note in some embodiments, the receive unit 103 could be configured to, instead of splitting the optical radiation received from the sensing optical fibre 102 to each of the first and second optical paths 107a and 107b, to switchably direct received optical radiation to one of the first and second optical paths, e.g. using an optical switch. The optical switch may be configured to alternate between directing received optical radiation to the first and second optical paths in a controlled manner.

For example, if the transmit unit is configured 101 is configured to transmit a series of pulse pairs as discussed above with reference to FIG. 2, the receive unit 103 may be configured to synchronise to the sequence of pulse pairs and to control an optical switch to direct any optical radiation received from a first pulse of a pulse pair to the first optical path 107a and direct any radiation of a second pulse of a pulse pair to the second optical path 107b. The optical switch will need to be fast enough switch between the paths in a period between the end of the first pulse of a pulse pair and the start of the second pulse in the pulse pair. In this way, each first pulse of a received pulse pair will be directed to the first optical path and delayed by the period Δt, to be mixed with the second pulse which has been directed to the second optical path 107b. The relative delay Δt provided by first optical path will again be matched to the temporal separation between the pulses of the pulse pair as generated by the transmit unit, but this switching approach may allow for a relatively short interval between successive pulse pairs. For instance, if the width of the pulses was 0.1Δt and the optical switch could switch between the two optical paths in 0.05Δt the period between the start of each pulse pair could be as short as 1.15Δt.

The principle of switching received radiation between the first and second optical paths could also, if desired, by applied to the embodiment of FIG. 1 in which the optical radiation is transmitted in continuous wave form. For instance, optical radiation received during a first period may be directed to the first optical path 107a and optical radiation received for a second, subsequent period, could be directed to the second optical path 107b, where the durations of the first and second periods are chosen to ensure as least some overlap in optical radiation travelling via the first optical path 107a with optical radiation of the second optical path 107b. In some instances the first period could be equal to the second period and both equal to the relative delay period Δt. If the receive unit repeatedly operated in this fashion, this would result in periods of Δt in duration where optical radiation delayed via the first optical path 107a interferes with optical radiation passing via the second optical path 107a, interspersed with periods of Δt in duration where there is no interference. This would therefore limit the sample rate of the sensor, but avoids splitting of the received optical radiation.

As the sensing technique of embodiments of the present disclosure relies on analysis of optical radiation which has propagated through the sensing optical fibre, rather than analysing backscatter say as for DAS, significant lengths of optical fibre can be used as the sensing optical fibre, and as noted above the sensing optical fibre could in some instances be of the order of 1000 km or more in length, particularly if optical amplifiers are used.

However, as the analysis is performed on optical radiation which has propagated through the entire length of the sensing optical fibre, the derivate signal generated indicates any optical path length changes affecting any part of the sensing optical fibre. Thus, based on the derivate signal determined just at the receive end it is not possible to determine the location along the length of the optical fibre of any disturbance.

In at least some embodiments, location of a disturbance can be provided by performing bidirectional sensing, i.e. by performing fibre optic sensing in both directions over the same path.

FIG. 3 illustrates one example of a sensing apparatus for bidirectional sensing. FIG. 3 illustrates that a first transmit unit 101a is configured to launch optical radiation into a first end of a fibre optic cable structure comprising a sensing optical fibre 102 and a first receive unit 103a is configured to receive radiation from the sensing optical fibre 102 at a second end of the fibre optic cable structure. In addition, a second transmit unit 101b is located at the second end of fibre optic cable structure to launch optical radiation into a sensing optical fibre to be received by a second receive unit 103b at the first end. In this example, the same optical fibre 102 may be used for transmission optical radiation in both directions.

Each of the first and second transmit units 101a and 101b and each of the first and second receive units 103a and 103b may operate as described above with reference to FIG. 1 or 2. In use, the first transmit unit 101a and first receive unit 103a operate to provide sensing at generally the same time as the second transmit unit 101b and the second receive unit 103b, and the first and second receive units 103a and 103b generate respective first and second measurement signals Sa and Sb.

In use, any disturbance that acts on a particular part of the sensing optical fibre 102, e.g. such as an illustrated disturbance 301, which results in a variation in optical path length of the sensing optical fibre 102 will affect optical radiation travelling in either direction within the sensing optical fibre, and thus can lead to a detectable derivative signal from both the first and second receive units, such that the same general disturbance will be present in each of the measurement signals Sa and Sb.

The location of the disturbance along the sensing optical fibre can be determined by the relative time at which the disturbances appear in the two measurement signals Sa and Sb. For instance, consider that a disturbance starts acting on the sensing fibre at a time Tx and at a distance Dx into the sensing fibre. The disturbance varies the optical path length of the sensing optical fibre at that point, which affects optical radiation propagating in the optical fibre 102 at that point at that time. Clearly, however, it is not until the affected optical radiation reaches the relevant receive unit 103a or 103b that the impact of the relevant disturbance will appear in the relevant measurement signal Sa or Sb, which depends on the propagation time from the location of the disturbance Dx to the relevant end of the fibre. If the disturbance occurred exactly halfway along the length of the sensing optical fibre 102, the length L1 of optical fibre between the disturbance and the first end of the would be the same as the length L2 between the disturbance and the second end, and the effect of the disturbance would appear in the measurement signals Sa and Sb at the same time. However, if the disturbance occurs closer to one end, say the first end, the length L1 will be shorter than the length L2 and the disturbance will appear in the first measurement signal Sa. The time difference between the disturbance appearing in the two measurement signals will depend on the difference in the propagation lengths L1 and L2 and thus by identifying the same disturbance in the measurement signals, Sa and Sb, and determining the time difference between appearance of the disturbance, the location of the disturbance can be detected.

If the Ta is the time at which the disturbance appears in the first measurement signal, Tb is the time at which the disturbance appears in the first measurement signal and Ttot is the propagation time for optical radiation through the total length of the optical fibre, then: (Ta−Tb)/Ttot represents the relative location of the disturbance in a normalised range from −1 (being at the first end) to +1 being at the second end. If the total length of the optical fibre is Ltot, this can be expressed in terms of distance from the first end as:

$$[ ( Ta - Tb ) / 2 Tot + 0.5 ) ] * Ltot \qquad Eqn . 2$$

For example, consider a sensing optical fibre with an example total length of 2000 km. If, for the purposes of illustration, the optical fibre had a refractive index of 1.5, the propagation time for optical radiation to travel the whole length of the optical fibre would be 10 ms. In this case, if a disturbance is detected in the first measurement signal Sa at time which is 8 ms before the disturbance is detected in the second measurement signal Sb, i.e. Ta−Tb=−8 ms, then the location of the disturbance would be 200 km from the first end.

In order to detect the effect of the same disturbance in each of the first and second measurement signals, the first and second measurement signals Sa and Sb may be correlated with one another, i.e. analysed to detect any correlation in the measurement signals indicative of the effects of the same disturbances. As will be understood by one skilled in the art, the disturbances of interest will generally persist for some time and have some characteristic signature or pattern, will result in a corresponding signature in each of the measurement signals. By identifying corresponding signatures in each of the measurement signals, Sa and Sb, the effects of the same disturbance can be identified in the measurement signals, for instance by cross-correlation. The measurement signals Sa and Sb from the respective first and second receive units 103a an 103b may thus be analysed by a signal processor 302 to perform correlation to identify the same disturbance in each of the measurement signals and to identify the time at which the relevant signature appears in each of the measurement signals. The location of the disturbance can then be determined.

FIG. 4 thus illustrates a flow chart illustrating a method of fibre optic sensing to detect a disturbance on a sensing optical fibre according to an embodiment. The method involves launching 402 optical radiation into both first and second ends of a fibre optical cable structure. At each of the first and second ends of the sensing optical fibre, radiation which has propagated through the sensing fibre is received and mixed with optical radiation received a short time earlier to form a derivative signal 402. The respective derivate signals are demodulated to provide respective first and second measurement signals. The first and second measurement signals are then correlated 403 to identify a disturbance in both measurement signals. A time difference between the disturbance in each measurement signal is determined 404 and the location may be determined 405 based on the determined time difference.

In the examples of FIGS. 3 and 4 the same sensing optical fibre is used for the bidirectional sensing. This can be advantageous as it requires use of only a single optical fibre and any changes in optical path length of that sensing optical fibre will clearly be the same for the radiation in both directions. Such bidirectional sensing can be achieved by using circulators 301-1 and 302-2 or the like as would be understood by one skilled in the art.

It would, however, be possible to use a first sensing optical fibre for sensing in a first direction and a second optical fibre, which is deployed along the same path as the first optical fibre, as a sensing optical fibre for sensing in the other direction. Thus the first transmit unit 101a and first receive unit 103a could be coupled to transmit and receive optical radiation via the first optical fibre whilst the second transmit unit 101b and second receive unit 103b could be coupled to transmit and receive optical radiation via the second optical fibre. The first and second optical fibres could, for example, be separate optical fibres in a fibre optic cable structure. A disturbance acting on the cable structure would cause the same general pattern of optical path length changes in both the first and second optical fibres, even if the exact extent of the change in optical path length varied, e.g. due to different coupling between the stimulus and the relevant sensing optical fibre. Correlation between the first and second measurement signals would thus still identify the same disturbance in the relevant measurement signals. This approach would require the use of two sensing optical fibres deployed along the same path, but two such optical fibres may be present in many long-distance cables, e.g. telecommunications cables typically comprise multiple optical fibres and power cables and the like may include optical fibres to allow for communication with multiple optical fibres provided for redundancy. Using separate sensing fibres for sensing in each direction may allow for higher launch powers of optical radiation without the onset of non-linear effects. Many existing telecom systems are designed so that they can only transmit along one particular direction on any fibre and so if this sensing approach were used on such a system it would have to use different fibres in the two directions.

Embodiments thus provide for methods and apparatus for sensing of disturbances on optical fibres which may, in particular, be long optical fibres, say of the order of several hundreds of kilometres or say 1000 km or more. There are a variety of application where monitoring for disturbances on long fibre may be advantageous. For instance, long distance monitoring may be of interest in various seismology applications, e.g. for detecting seismic waves or seismic events in locations that otherwise are different to monitor, e.g. across large bodies of water. Monitoring of long-distance submarine fibre optical cables, as may already have been deployed for telecommunications, may allow for seismic monitoring in subsea environments over long distances without requiring the installation of multiple costly underwater seismic monitoring stations, which may be useful for research and for earthquake prediction/tsunami warning or the like.

In some cases it may be desirable to monitor a long-distance cable, such as a telecommunications cable or power cable or the like, to detect any disturbances that could indicate possible damage to the cable, e.g. for a submarine cable to detect significant disturbance due to the cable structure than may indicate damage from the environment. Other applications may include monitoring of long-distance transport networks, e.g. road or rail system, border or perimeter monitoring or monitoring of long-distance structures such as pipelines.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A fibre optic sensing apparatus, comprising:
a first receive unit comprising:
an optical arrangement configured to receive coherent optical radiation that has propagated through a sensing optical fibre and to form first and second optical signals from the optical radiation received, wherein the second optical signal comprises optical radiation received from the sensing optical fibre later than the optical radiation of the first optical signal by a defined time period;
a photodetector configured to detect the first optical signal mixed with the second optical signal; and
a processor configured to process an output of the photodetector to demodulate a derivative signal formed by interference of the first and second optical signals.

2. The fibre optic sensing apparatus of claim 1, wherein the optical arrangement is configured to direct optical radiation received from the sensing optical fibre into first and second optical paths to provide the first and second optical signals, wherein the first optical path comprises an optical delay for imposing a delay relative to the second optical path equal to said defined time period.

3. The fibre optic sensing apparatus of claim 2, wherein the optical delay comprises a fibre optic loop.

4. The fibre optic sensing apparatus of claim 2, wherein the optical delay is configured such that said defined time period is within the range of 5-25 microseconds inclusive.

5. The fibre optic sensing apparatus of claim 2, wherein at least one of the first and second optical paths comprises a modulator configured to apply a frequency shift to optical radiation in the relevant optical path such that the first optical signal differs in frequency from the second optical frequency by a defined frequency difference.

6. The fibre optic sensing apparatus of claim 5, wherein the processor is configured to demodulate the derivative signal at a carrier frequency equal to said defined frequency difference.

7. The fibre optic sensing apparatus of claim 2, wherein the receive apparatus is configured such that the optical radiation received from the sensing optical fibre comprises a repeating sequence of pulses pairs, each pulse pair comprising a first pulse at a first frequency and a second pulse at a second different frequency.

8. The fibre optic sensing apparatus of claim 7, wherein the defined time period of the optical delay is configured such that, when mixed together, at least part of a in first pulse of a pulse pair of the first optical signal overlaps with at least part of a second pulse of a pulse pair of the second optical signal.

9. The fibre optic sensing apparatus of claim 7, wherein the defined time period of the optical delay is configured to substantially match a temporal separation between the first and second pulses of a pulse pair.

10. The fibre optic sensing apparatus of claim 1 further comprising:
a first transmit unit comprising an optical source configured to launch coherent optical radiation into the sensing optical fibre.

11. The fibre optic sensing apparatus of claim 7, further comprising a first transmit unit comprising an optical source configured to launch coherent optical radiation into the sensing optical fibre, wherein the first transmit unit comprises a coherent optical source and at least one modulator configured to modulate optical radiation from the coherent optical source to form said pulse pairs.

12. The fibre optic sensing apparatus of claim 10 further comprising the sensing optical fibre.

13. The fibre optic sensing apparatus of claim 12, wherein the sensing optical fibre is at least 1000 km in length.

14. The fibre optic sensing apparatus of claim 10, wherein:
the first transmit unit is located at the first end of a fibre optical cable structure comprising the sensing optical fibre and the first receive unit is located at a second end of said fibre optical cable structure, the first receive unit being configured to generate a first measurement signal; and the fibre optic sensing apparatus further comprises:
a second transmit unit located at the second end of the fibre optical cable structure and a second receive unit located at the first end of the fibre optical cable structure, wherein the second receive unit is configured to receive optical radiation transmitted from the second transmit unit via the fibre optic cable structure, and to process the received optical radiation in the same way as the first receive unit to form a second measurement signal.

15. The fibre optic sensing apparatus of claim 14 further comprising a signal processor configured to correlate the first and second measurement signals to identify a disturbance signature in both the first and second measurement signals.

16. The fibre optic sensing apparatus of claim 15, wherein the signal processor is further configured to determine any time difference between the disturbance signature in the first and second measurement signals and to determine a location along the fibre optical cable structure for the disturbance based on the determined time difference.

17. The fibre optic sensing apparatus of claim 14, wherein the second transmit unit is configured to transmit optical radiation to the second receive unit via the same sensing optical fibre as the first transmit unit and first receive unit.

18. A method of fibre optic sensing comprising:
launching coherent optical radiation into a sensing optical fibre at a first end of a fibre optic cable structure;
receiving, at a second end of the fibre optical cable structure, the optical radiation that has propagated through the sensing optical fibre;
forming first and second optical signals from the optical radiation received at the second end, wherein the second optical signal comprises optical radiation received from the sensing optical fibre later than the optical radiation of the first optical signal by a defined time period;
mixing the first optical signal with the second optical signal and detecting the mixed signal; and
processing the detected mixed signal to demodulate a derivative signal formed by interference of the first and second optical signals to generate a first measurement signal.

19. A method as claimed in claim 18 further comprising:
launching coherent optical radiation into a sensing optical fibre at the second end of the fibre optic cable structure;
receiving, at a first end of the fibre optical cable structure, the optical radiation that has propagated through the sensing optical fibre;
forming third and fourth optical signals from the optical radiation received at the first end, wherein the third optical signal comprises optical radiation received from the sensing optical fibre later than the optical radiation of the fourth optical signal by a defined time period;
mixing the third optical signal with the fourth optical signal and detecting the mixed signal; and
processing the detected mixed signal to demodulate a derivative signal formed by interference of the first and second optical signals to generate a second measurement signal.

20. (canceled)

21. A fibre optic sensing apparatus, comprising:
a signal processor configured to receive a first measurement signal and a second measurement signal from respective first and second fibre optic sensing receive units located at opposite ends of a fibre optic cable structure,
wherein each of the first and second measurements signals comprise signals generated by receiving coherent optical radiation that has propagated through a sensing optical fibre of the fibre optical cable structure, mixing a first optical signal formed from the optical radiation received with a second optical signal comprising optical radiation received from the sensing optical fibre later than the optical radiation of the first optical signal by a defined time period and detecting and demodulating a derivative signal formed by interference of the first and second optical signals;
wherein the signal processor is configured to identify a disturbance signature in both the first and second measurement signals, identify a time difference between the disturbance signature in each measurement signal and determine a location of the disturbance along the fibre optic cable structure based on the determined time difference.

22. (canceled)
